(19) United States
(12) Patent Application Publication
(10) Pub. No.: US 2012/0070232 A1
(43) Pub. Date: Mar. 22, 2012

(54) INSTALLATION OF LEAKAGE BARRIERS TO ENHANCE YIELD OF MINERAL DEPOSITS IN UNLINED SOLAR POND SYSTEMS

(75) Inventors: Mark Reynolds, Clinton, UT (US); Thomas S. Burton, Ogden, UT (US); Corey R. Milne, Ogden, UT (US); Steven R. Day, Littleton, CO (US)

(73) Assignee: GREAT SALT LAKE MINERALS CORPORATION, Overland Park, KS (US)

(21) Appl. No.: 13/240,597

(22) Filed: Sep. 22, 2011

Related U.S. Application Data
(60) Provisional application No. 61/385,449, filed on Sep. 22, 2010.

(51) Int. Cl. E02B 7/02; C04B 28/04; C04B 28/08; C04B 14/00

(52) U.S. Cl. 405/116; 106/811; 106/718; 106/790

(57) ABSTRACT

Slurry walls and methods of using those slurry walls to seal unlined solar ponds are provided. The slurry walls are formed from a mixture comprising clay and cement in water. A trench is keyed into the dike surrounding the solar pond, down to a geotechnically predetermined level. The slurry is deposited into the trench and allowed to harden, after which it is covered with a membrane or other covering. The inventive slurry walls reduce, and preferably prevent, leakage of water from the solar pond.

### CROSS-REFERENCE TO RELATED APPLICATIONS

The present application claims the priority benefit of U.S. Provisional Patent Application Ser. No. 61/385,449, filed Sep. 22, 2010, entitled, INSTALLATION OF LEAKAGE BARRIERS TO ENHANCE YIELD OF MINERAL DEPOSITS IN UNLINED SOLAR POND SYSTEMS, incorporated by reference in its entirety herein.

### BACKGROUND OF THE INVENTION

1. Field of the Invention

The present invention is concerned with using a slurry wall to seal solar ponds, thus reducing, and preferably preventing, leakage from the solar pond.

2. Description of the Prior Art

Solar ponds have long been used to recover minerals from brine sources. While some pond systems are small enough to be rubber- or plastic-lined, most solar ponds designed for mineral recovery have been constructed from native or imported rock or soils. The native soils are used as a base material for the pond, while native or imported soil and rock is raised to create a perimeter dike.

Rock and earthen solar ponds naturally leak brine to adjacent soils. Most unlined solar pond systems can lose as much as 70% of the pumped-in brine to leakage. The more a solar pond leaks, the higher the required pumping rate to keep up with losses.

Since the late 1800s, operators of solar ponds have attempted to reduce leakage in an effort to reduce their pumping costs. Leakage reduction has been attempted mainly in two ways. Some solar pond dikes have been constructed directly from native clays, using the properties of these clays to slow leakage. The issue with clay dikes is that wave action often erodes these dikes, requiring constant repairs or eventually covering them with imported materials. Some solar pond operators have not attempted leakage reduction, relying on the leakage to reduce during the solar evaporation season as the small pores in the dike materials fill with precipitated minerals and “salt up.”

There is a need for improved methods of reducing and preferably preventing solar pond leakage.

### SUMMARY OF THE INVENTION

The present invention broadly provides a method of reducing or preventing leakage from a solar pond. The method comprises forming a slurry wall in a dike adjacent the solar pond, with the slurry wall being formed from a mixture comprising clay, cement, and water.

In another embodiment, the invention provides a modified solar pond comprising a solar pond having a dike adjacent thereto. The modified solar pond also comprises a slurry wall in the dike, with the slurry wall being formed from a mixture comprising clay, cement, and water.

In a further embodiment, a slurry wall formed from a hardened mixture is provided. The mixture before hardening comprises:
from about 3% to about 25% by weight cement, based upon the total weight of the mixture taken as 100% by weight;
from about 1% to about 15% by weight clay, based upon the total weight of the mixture taken as 100% by weight; and
water.

### BRIEF DESCRIPTION OF THE DRAWINGS

FIG. 1 is a graph showing the monitoring of brine levels in a test pond sealed with a slurry wall according to the present invention.

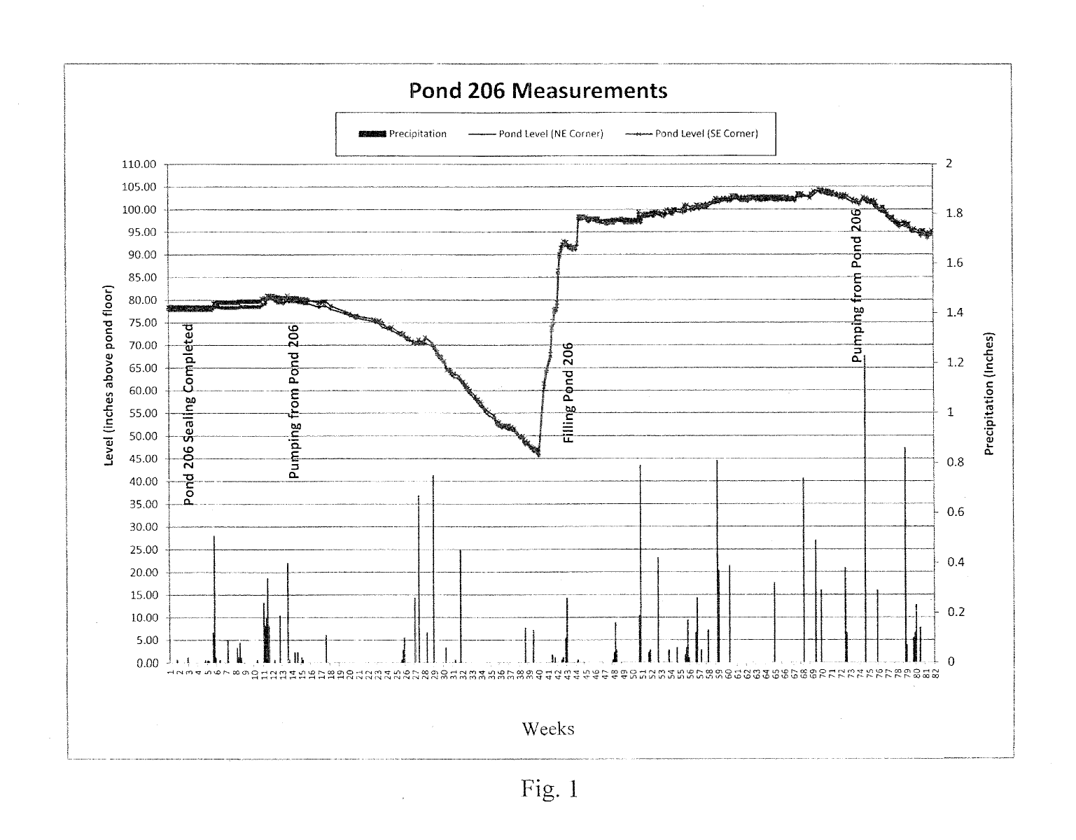

### DETAILED DESCRIPTION OF THE PREFERRED EMBODIMENTS

The present invention provides a method of reducing and even preventing leakage from solar evaporation ponds, and particularly unlined solar evaporation ponds. As will be understood by those skilled in the art, a solar evaporation pond is a shallow pool designed to produce salts from brine (sea water or other mineral-laden waters). The brines are fed into large ponds, and water is drawn out through evaporation, which allows the salt to be deposited and subsequently harvested.

In the present invention, an aqueous slurry is used to form the slurry wall. In more detail, the aqueous slurry comprises clay, cement, and water. Preferably, the cement is present in the slurry mixture at levels of from about 3% by weight to about 25% by weight, preferably from about 8% by weight to about 20% by weight, more preferably from about 15% by weight to about 20% by weight, and even more preferably from about 13% by weight to about 20% by weight, based upon the total weight of the slurry mixture taken as 100% by weight. Preferred cements are those selected from the group consisting of Types II-V Portland cements (such as those obtainable from Holcim Cement, Ogden, Utah); Blast Furnace Slag cement, Grade 100 (such as that obtainable from Holcim Cement, Chicago, Ill.); Blast Furnace Slag cement, Grade 120 (such as that obtainable from Lafarge Cement, Chicago, Ill.), and mixtures of the foregoing. Particularly preferred cements are Types II-V, sulfate-resistant Portland cements.

In one embodiment, the cement used is both one of the above Portland cements and Blast Furnace Slag cement. In this embodiment, it is preferred that the Portland cement be present at levels of from about 0.5% by weight to about 20% by weight, preferably from about 0.5% by weight to about 4% by weight, and even more preferably about 1% by weight, and that the Blast Furnace Slag cement be present at levels of from about 10% by weight to about 15% by weight, and more preferably about 12.5% by weight, based upon the total weight of the slurry mixture taken as 100% by weight.

Preferably, the clay is present in the slurry mixture at levels of from about 1% by weight to about 15% by weight, preferably from about 3% by weight to about 13% by weight, more preferably from about 4% by weight to about 10% by weight, and even more preferably from about 4% by weight to about 6% by weight, based upon the total weight of the slurry mixture taken as 100% by weight. Preferred clays include those selected from the group consisting of API Standard bentonite clay (such as that obtainable from Western Clay, Aurora, Utah); SW-101 modified bentonite clay (such as that obtainable from Wyo-Ben, Greybull, Wyo.); Sepiolite clay (such as that obtainable from Federal Bentonite, Houston, Tex.); Attapulgite clay (such as that obtainable from Active Minerals, Quincy, Fla.), and mixtures of the foregoing. The most preferred bentonite is premium grade, ultrafine, sodium cation based montmorillonite powder (Wyoming type bentonite) that meets or exceeds the requirements of API 13A, Section 9, 2004 edition.

As for the water used to form the slurry, the balance of the slurry will generally be water, although optional additives (e.g., soda ash, viscosity modifying polymers) could also be included. This will typically result in a water level of from about 60% by weight to about 96% by weight, preferably from about 67% by weight to about 89% by weight, and more preferably from about 70% by weight to about 86% by weight, based upon the total weight of the slurry taken as 100% by weight.

In one embodiment, the water will preferably have the properties shown in Table A:

TABLE A

| PROPERTY | BROADEST | PREFERRED |
|---|---|---|
| pH | from about 6.0 to | from about 7.0 to |
| | about 9.5 | about 9.3 |
| hardness (ppm) | less than about 400 | less than about 225 |
| alkalinity (ppm) | less than about 400 | less than about 235 |
| total dissolved solids | less than about 4,000 | less than about 1,000 |
| (ppm) | | |
| density (gm/cc) | from about 1.0 to | from about 1.0 to |
| | about 1.04 | about 1.02 |
| apparent viscosity (cP) | 0.8 to about 2 | from about 1 to |
| | | about 1.5 |

In another embodiment, the water will preferably have the properties shown in Table B:

TABLE B

| PROPERTY | BROADEST | PREFERRED |
|---|---|---|
| pH | from about 7.0 to | from about 8.5 to |
| | about 9.0 | about 8.8 |
| hardness (ppm) | less than about 600 | less than about 475 |
| alkalinity (ppm) | less than about 400 | less than about 300 |
| total dissolved solids | less than about | less than about |
| (ppm) | 200,000 | 160,000 |
| density (gm/cc) | from about 1.05 to | from about 1.07 to |
| | about 1.21 | about 1.15 |
| apparent viscosity (cP) | 0.8 to about 2 | from about 1 to about 1.5 |

In the embodiment of Table B a preferred water for use in the mixture is from the south arm of the Great Salt Lake.

A preferred slurry wall mixture will comprise, preferably consist essentially of, and more preferably consist of: from about 3% by weight to about 25% by weight cement; from about 1% by weight to about 15% by weight clay; and from about 60% by weight to about 96% by weight water, based upon the total weight of the slurry mixture taken as 100% by weight. One particularly preferred mixture comprises Portland Cement (preferably about 17% by weight) and bentonite (preferably about 6% by weight), preferably with the water of Table A. Another particularly preferred mixture comprises Portland Cement (preferably about 1% by weight), blast furnace slag cement (preferably about 12.5% by weight), and sepiolite (preferably about 5.5% by weight), preferably with the water of Table B.

The slurry wall is formed in a manner very similar to conventional methods of forming slurry walls. More particularly, a trench is formed (keyed) in the dike (bank, adjacent ground, etc.) in which the wall is to be built. The trench is dug to a depth predetermined by geotechnical analysis to provide an economical reduction in pond leakage, typically penetrating into an underlying clay layer. More particularly, this depth is determined by geotechnical sampling and seepage analysis. The width of the slurry wall will typically be from about 1 feet to about 5 feet, and preferably from about 2 feet to about 4 feet. The trench is preferably dug around the entire perimeter of the solar pond, so that the entire pond is ultimately surrounded by the slurry wall.

Another consideration in forming the trench is that of the required hydraulic head in the slurry trench during installation. The slurry wall should be constructed such that the slurry is always at least about 5 feet above groundwater level and not more than about 3 feet below the top of trench during excavation. This is important because if the slurry in the trench does not provide sufficient hydraulic pressure throughout the depth of the trench, fluid in the soils may displace the slurry and create “holes” in the wall that will increase the permeability of the slurry wall. This becomes particularly problematic in solar pond brine. Fluid specific gravity for such brine ranges from 1.1 to 1.4 g/cc, much higher than fresh water. The extra weight of the pond brine will have even more tendency to displace the lighter slurry wall mixture and create holes in the wall. The above specified heights avoid reduction in the integrity of the wall and may be increased with higher brine densities.

The clay is agitated in the presence of water, separately from the cement. The cement is also agitated in the presence of water, separately from the clay. The water can be treated, if needed, to remove impurities that might interfere with the hydration process. Any optional ingredients can be added to the slurry mixture. The slurry mixture should have a Marsh Funnel viscosity of from about 20 seconds to about 70 seconds, and preferably from about 35 seconds to about 55 seconds. Furthermore, the density of the slurry mixture should be from about 1.03 gm/cc to about 1.40 gm/cc, and preferably from about 1.10 gm/cc to about 1.30 gm/cc.

The slurry mixture is then placed into the trench and allowed to harden (as measured by a penetrometer), which typically takes less than about 7 days, preferably less than about 4 days, and preferably from about 1 day to about 4 days (as measured by a penetrometer). After about 2 weeks, a membrane or other covering can be placed on the top of the wall, followed by covering the wall with dirt.

The final slurry wall will have a number of highly desirable properties. For example, the slurry wall will have a permeability of less than about 1×10⁻⁴ cm/see, preferably less than about 1×10⁻⁵ cm/sec, and more preferably less than about 1×10⁻⁶ cm/sec. The slurry wall will preferably have an unconfined compressive strength of at least about 2.5 psig, preferably at least about 3 psig, and more preferably from about 3 psig to about 50 psig about 7 or more days after the slurry wall is formed. Finally, the slurry wall has a slake decay of less than about 25% by volume, preferably less than about 15% by volume, and preferably less than about 10% by volume about 30 or more days after the slurry wall is formed (i.e., the wall is stable after 30 days).

### EXAMPLES

The following examples set forth preferred methods in accordance with the invention. It is to be understood, however, that these examples are provided by way of illustration and nothing therein should be taken as a limitation upon the overall scope of the invention.

### Materials and Methods

Table 1 sets forth the standards and methods utilized to test a number of the properties described herein.

TABLE 1
Laboratory Standards and Methods

| Test | Standard or Reference |
|---|---|
| Grainsize of soils | ASTM D6913 |
| Fines Content | ASTM D1140 |
| Atterberg Limits | ASTM D4318 |
| Moisture Content | ASTM D2216 |
| Soil Classification (USCS) | ASTM D2487 |
| Water Quality (ph, Hardness, TDS) | Hach Test or equal |
| Slurry & Grout Preparation | API 13A mod. |
| Sample Preparation | ASTM D4832 mod. |
| Slump (mini-slump method) | ASTM D143 mod. |
| Viscosity and Density | API RP 13B-1 |
| Filtrate, pH, and Temperature | API RP 13B-1 |
| Bleed and Set | ASTM C940 mod. |
| Penetration Resistance | ASTM D1558 mod. |
| Unconfined Compressive Strength (UCS) | ASTM D1633/4832 mod. |
| Hydraulic Conductivity (permeability) | ASTM D5084/7100 mod. |
| Pan-Set | CRA, June 1991 |
| Slake/Immersion | ASTM C267, D4644 mod., & |
| | Bodocsi 1988*. |
| Chemical Desiccation | Alther et al.** |
| Sedimentation/Flocculation | Ryan 1987*** |
| Long-term Filtrate w/Leachate | D'Appolonia 1980**** |

*Bodosci, A, Bowers, H. T., and Shere, R., “Reactivity of Various Grouts to Hazardous Wastes and Leachates,” Hazardous Waste Engineering Research Laboratory, Cincinnati, OH, 1988.
**Alther, G., Evans, J. C., Fang, H-Y, and Witmer, K., “Influence of Inorganic Permeants upon the Permeability of Bentonite,” Hydraulic Barriers in Soil and Rock, ASTM STP 874, A. I. Johnson, R. K. Frobel, N. J. Cavalli, and C. B. Pettersson, Eds., American Society for Testing and Materials, Philadelphia, 1985, pp 64-73.
***Ryan, C. R., “Vertical Barriers in Soil for Pollution Containment,” Proceedings: Geotechnical Practice for Waste Disposal, GSP No. 13, American Society of Civil Engineers Specialty Conference, Ann Arbor, MI, June 1987.
****D'Appolonia, D. J., “Soil-Bentonite Slurry Trench Cutoffs,” Journal of the Geotechnical Engineering Division, American Society of Civil Engineering, Vol. 106, No. GT4, April 1980.

Constant Head Permeability Tests (ASTM D5084) were performed on samples of the CB mixture with a gradient of less than 30 and a confining stress of 10 psig. (“CB” as used herein is an abbreviation for cement-bentonite-water mixtures, as well as cement-clay-water mixtures, generally. The context in which it is used will allow identification of the clay that was used.) Pond 112 brine was used as the permeant and forced through the test specimens for a minimum of seven days in order to assess trends in permeability with extended time and flow.

For the slake/immersion tests, a modified version of ASTM C267 was employed to investigate the CB stability. The modification lowered the maximum acceptable change in volume to 10% after 84 days of immersion. Slake tests began after 14 days of standard curing.

Table 2 sets forth the materials used in the following tests.

TABLE 2
Materials

| Material | Source | Abbreviation |
|---|---|---|
| API Standard bentonite | Western Clay, Aurora, UT | Bento |
| clay | | |
| Bentonite plus soda ash | Western Clay & lab stock | BSA |
| SW-101 modified bentonite | Wyo-Ben, Greybull, WY | SW 101 |
| clay | | |
| Sepiolite clay | Federal Bentonite, Houston, | Sepio |
| | TX | |
| Attapulgite clay | Active Minerals, Quincy, FL | Atta |
| Soda Ash | Lab stock | SA |
| Hydroxyethylcellulose-N | Aqualon, Maumee, OH | HEC-N |
| polymer | | |
| Hydroxyethylcellulose-K | Rantec, Sheridan, WY | HEC-K |
| polymer | | |
| 250G polymer additive | Aqualon, Maumee, OH | 250G |
| 180GR polymer additive | Aqualon, Maumee, OH | 180GR |
| Guar-C natural polymer | Rantec, Sheridan, WY | Guar |
| Spersene CF | Federal Bentonite, Houston, | Spersene |
| | TX | |
| Types II-V Portland cement | Holcim Cement, Ogden, UT | PC |
| Blast Furnace Slag cement, | Holcim Cement, Chicago, IL | BFS or BFS |
| Grade 100 | | 100 |
| Blast Furnace Slag cement, | Lafarge Cement, Chicago, IL | BFS or BFS |
| Grade 120 | | 120 |
| Process Water | GSLM*, Ogden, UT | Process |
| 1B Brine Water | GSLM, Ogden, UT | Brine |
| Bitterns Pond Water | GSLM, Ogden, UT | Bitterns |
| Dike Material | GSLM, Ogden, UT | Borrow |
| Pond Floor Material | GSLM, Ogden, UT | Key |
| Pond 112 brine | GSL, Lake Side, UT | 112 |
| South arm of the Great | GSL, Lake Side, UT | SGSL |
| Salt Lake Water/Brine | | |
| North arm of the Great | GSL, Lake Side, UT | NGSL |
| Salt Lake Water/Brine | | |
| Dike Material | GSL, Lake Side, UT | Soil |

*Great Salt Lake Mineral Corporation

The GSLM waters were significantly different from tap water and were considered unusual for slurry wall applications. The Process water was available as a slurry mix water, but had a very high TDS content, which would normally be a distinct disadvantage when using most bentonite clays. The high densities and viscosities of the Brine and Bittern waters was worth noting.

For the water (brines) tested and utilized, “NGSL” refers to water north of the RR causeway that divides the Great Salt Lake, while “SGSL” refers to water south of the RR causeway. Pond “112” water is water contained by Great Salt Lakes Mineral Corporation at the West Ponds site. Collectively, these three waters are brines.

The water labeled “Brine” was Great Salt Lake waters that were routing through the solar evaporation pond system. For the “Bitterns,” this was brine that has a high concentration of MgCl₂. Finally, “Process” water was fresh water that was used as plant process water delivered via canal from the Willard Bay Reservoir.

All of these waters were characterized and compared to tap and sea water (Table 3).

TABLE 3
GSL and Tap Waters

| Designation | Tap* | Sea* | Process | Brine | Bitterns | SGSL | NGSL | 112 |
|---|---|---|---|---|---|---|---|---|
| pH | 6 to 8 | ~8 | 9.1 | 7.1 | 4.9 | 8.7 | 7.9 | 8.0 |
| Hardness | 50-300 | >400 | 250 | >425 | 50 | >425 | >425 | >425 |
| (ppm) | | | | | | | | |
| Alkalinity | 50-150 | >400 | >240 | >240 | 40 | >240 | >240 | >240 |
| (ppm) | | | | | | | | |
| TDS (ppm) | 0-500 | ~35,000 | 2,000 | 360,000 | 320,000 | 111,400 | 154,800 | 170,750 |
| Density | 1.0 | 1.03 | 1.01 | 1.27 | 1.33 | 1.07-1.11 | 1.17-1.19 | 1.18 |
| (gm/cc) | | | | | | | | |
| Apparent | 1 | ~1 | 1 | 8 | 19.5 | 1 | 1.5 | 1.5 |
| Viscosity | | | | | | | | |
| (cP) | | | | | | | | |

*typical properties

### Slurry Mixture Testing I

### 1. Clay Compatibility via Index Tests

Three commercial clays were tested for compatibility with GSLM waters: API Standard bentonite, sepiolite, and SW 101 salt-resistant bentonite. In addition, limited testing was performed on attapulgite and a mixture of clays. Both Brine and Process waters were used as mix water. The physical and rheological properties of the slurries are shown in Table 4.

TABLE 4
Clay Slurry Properties

| | Typical | | | | | | | |
|---|---|---|---|---|---|---|---|---|
| PROPERTY | API | | | | | | | |
| Clay | Bentonite | Bento | Sepo | SW 101 | SW 101 | Sepo + Bento | Sepo | Atta |
| Mix Water | Clean | Process | Process | Process | Process | Process | Brine | Brine |
| Hydration? | >16 hr | >16 hr | No | >16 hr | >16 hr | No | no | no |
| Clay/W (%) | 6.4 | 6.4 | 6.4 | 6.4 | 4.3 | 7.9 | 6.4 | 6.4 |
| Density (gm/cc) | 1.03 | 1.03 | 1.03 | 1.04 | 1.025 | — | 1.3 | 1.3 |
| MF (sec) | >40 | 32 | 26 | 158 | 1 dy = 331 | 28 | 33 | 35 |
| | | | | | wk = 47 | | | |
| Gelation (sec) | >35 | 25 | 23 | 660 | 29 | — | 21 | 18 |
| AV (cP) | 15 | 7 | 3 | 35.5 | 12.5 | 5 | 7.5 | 10 |
| YP (lb/100sf) | 20 | 10 | 2 | 45 | 5 | 8 | 2 | 5 |
| Filtrate (ml) | <15 | 42 | 77 | 9.8 | 11.6 | — | — | — |
| Cake Th'k (mm) | 0.5-1.5 | 3.05 | 4.04 | 1.27 | 0.51 | — | — | — |
| pH | 7-9 | 8.25 | 8.24 | 8.59 | 8.25 | — | — | — |

SW 101 performed the best, making it appear to be the best candidate for use in slurry wall construction. Sepiolite performed better with Brine water than with Process water.

Next, index-type compatibility tests were performed with the clay slurries to detect potential gross incompatibility or other negative reactions between the clays and the GSLM waters. The tests were performed by first creating a standard slurry (Table 4) using Process water as the mix water, along with the selected clay, and then subjecting the selected clay to three challenge tests with the Pond waters.

The first challenge test was a chemical desiccation test to help determine if a water affects the chemical structure of the clay. Slurries were made with each of these clays, as previously described, and diluted 1:1 with either Process, Brine, Bitterns, or Tap water. These mixtures were poured onto glass plates and allowed to dry. The cracking pattern of the dried slurry was then examined for any unusual patterns. Comparisons were made between slurries diluted with tap water and GSLM waters. There was no cracking or unusual drying patterns in any test. The Bitterns sample did not fully dry (after 7 days), and salt particles were evident in both Bitterns and Brine test specimens. Thus, there were not any potential compatibility problems.

The second challenge test was the sedimentation/flocculation test, which was performed to help determine whether the clay will fall out of suspension in the presence of water during construction. Slurries were made with each of the clays and diluted 1:1 with Process, Brine, Bitterns, and Tap water, just as in the desiccation test above. The slurries were poured into graduated cylinders and then observed for one week. Comparisons were made between the slurries diluted with tap water. SW 101 provided the best results of the samples.

The third challenge test was the Modified Press Permeability test, which was performed to determine whether the water would degrade the filter cake of a particular clay, and thus, the long-term performance of the clay. The test was performed by first completing a standard filtrate test (30 minutes at 100 psi) with each of the clay slurries made with mix water (Process water in this case). Next, the supernate from each test was decanted and the cell (with filter cake still intact) refilled with test water (Tap, Brine, Process, Bitterns). The test cells were again pressurized (100 psi) and monitored an additional 3 hours. Typically, three pore volumes of water flow through the filter cake in 3 hours, simulating longer term performance. The flow rates were compared as the ratio of the filtrate of the test water to the filtrate of the mix water vs. the pore volumes of flow. A ratio of 1.0 demonstrates no effect of the test water on the filter cake. A ratio of 2, where test water flows through the filter cake twice as fast as Process water flows through the filter cake indicates potential incompatibility. The results of the filter press tests are summarized in Table 5.

TABLE 5
Modified Filter Press Test Results

| | | Standard | | Cake | Pore | Cake | Average |
|---|---|---|---|---|---|---|---|
| | Mix | Filtrate | | Thickness | Volumes | Permeability | Ratio |
| Clay | Water | (ml/30 min) | Water | (mm) | Flow | (cm/sec) | Water/Process |
| Bentonite | Process | 29 | Tap | 2.38 | 6.3 | 2.10E−07 | 0.448 |
| Bentonite | Process | 57.6 | Process | 3.56 | 4.2 | 7.10E−07 | 1.000 |
| Bentonite | Process | 32 | Brine | 2.29 | 8.6 | 1.80E−07 | 0.402 |
| Bentonite | Process | 29.3 | Bitterns | 2.38 | 2.2 | 6.30E−08 | 0.132 |
| Sepiolite | Process | 77 | Tap | 4.32 | 10.7 | 1.20E−06 | 0.956 |
| Sepiolite | Process | 83.6 | Process | 3.94 | 14.6 | 1.20E−06 | 1.000 |
| Sepiolite | Process | 76 | Brine | 3.05 | 5.7 | 3.20E−07 | 0.357 |
| Sepiolite | Process | 76 | Bitterns | 2.54 | 3.2 | 1.20E−07 | 0.163 |
| SW 101 | Process | 6.6 | Tap | 1.02 | 6 | 3.60E−08 | 1.078 |
| SW 101 | Process | 6.8 | Process | 0.76 | 7.4 | 2.50E−08 | 1.000 |
| SW 101 | Process | 6.4 | Brine | 0.51 | 24.8 | 2.50E−08 | 1.514 |
| SW 101 | Process | 6.7 | Bitterns | 1.02 | 2.7 | 1.90E−08 | 0.562 |

Several trends were observed from this data. First, different clays produced different standards filtrates. SW 101 typically produced the lowest filtrate, and sepiolite the highest. Bentonite produced a moderate filtrate, but with more variability. Second, the different waters produced different effects on the clay. The permeability of the filter cakes and ratio between the test waters and mix water are lowest, and thus best, with Bitterns and Brine waters. The combination of Bitterns/Process with SW 101 produced a very low filter cake permeability but a higher ratio was indicated with the SW 101 with Bitterns. Again, SW 101 produced the best overall compatibility (filtrate and permeability), but with a marginal result with Bitterns water (i.e., ratio with Bitterns was 1.514).

### 2. Grout Compatibility via Index Tests

Index-type compatibility tests were also performed with cement grouts to detect potential incompatibilities or reactions between the grouts and GSLM waters. The grouts formed were also poured into molds to harden and later used as test specimens for strength and permeability. The strength of the CB mixtures as they cured was tested under standard (ASTM D4832) conditions. The proportions and properties of the grouts tested are shown in Table 6.

TABLE 6
CB Grouts

| PROPERTY | Conventional | CB1 | CB2 | CB3 | CB4 |
|---|---|---|---|---|---|
| Cement | Portland | PC V | PC V | BFS/PC V | BFS/PC V |
| Clay | Bentonite | Sepo | Bento | Sepo | Bento |
| Mix Water | Clean | Brine | Process | Process | Process |
| Cement/W | 0.15 to 0.22 | 0.17 | 0.17 | 0.172 | 0.172 |
| Clay/W | 0.04 to 0.06 | 0.05 | 0.06 | 0.06 | 0.05 |
| Density (gm/cc) | 1.13 | 1.30 | 1.13 | 1.14 | 1.13 |
| MF viscosity | >35 | 37 | 32 | 51 | 30 |
| (sec) | | | | | |
| AV viscosity (cP) | >15 | 15.5 | 12.5 | 37 | 11.5 |
| Gel viscosity | <40 | 10 | 20 | 58 | 18 |
| (10 sec) | | | | | |
| Bleed (%) | <10 | 0 | 2 | 0 | 4 |
| pH | >9 | 8.5 | 12.8 | 12.2 | 12.3 |
| Penet'r at 3 days | >0.25 | DNS | 0.28 | 2.25 | 0.75 |
| (tsf) | | | | | |

DNS = did not set

Grout CB1 met workability expectations, but otherwise was unsuccessful. Brine water was used instead of Process water to maximize grout viscosity. CB2 and CB4 met all expectations except for the slightly lower viscosity. CB3 met all workability expectations. Based on these results, CB2-CB4 were deemed the top three candidates.

Two compatibility tests were performed on the CB grouts. In the Pan test, the fluid grout was poured into a pan filled with one of the GSLM waters. The grout was allowed to settle to the bottom of the pan and harden. The grouts were then tested for penetration resistance as they hardened under the waters to detect any observable differences in the setting process due to different waters. This test was performed on all four grouts.

The pan tests were not successful because the grouts could not settle normally in the more dense pond waters. Thus, the CB grouts “floated,” separated, and did not harden normally. CB1 did not set, while CB2 took quite awhile to settle, and then its set was disturbed, although there was clear evidence that it was hardening. CB3 separated, and no set was observed. CB4 also separated as it settled to the bottom of the pan, disturbing the set.

The pan test results indicated that the surface of the liquid slurry must be maintained to a higher elevation than the surrounding groundwater during slurry wall installation. These results also indicate that sufficient head (or free-board) must be maintained during slurry wall formation to force the CB through the Pond waters and into place in the trench. Thus, rather than the normal 3-foot slurry free-board, a free-board of at least about 5 feet, preferably at least about 6 feet, and more preferably from about 6 feet to about 9 feet is ideal.

The second cement compatibility test utilized was the slake immersion test. In this test, partially hardened cylinders of grout were immersed in test waters or chemicals and observed over time. The cylinders were regularly weighed and dimensioned so changes in density could be detected. Losses or gains in weight were used as indicators of compatibility. The cylinders were then sliced into sections or tested and photographed at the end of the test to provide additional indications. The tests were started after 14 days of normal curing.

The CB3 sample immersed in Brine fell apart after 14 days, and a few days later the CB3 in Bitterns did the same. CB4 performed better but did soften over time. For example, specimens of CB4 immersed in Pond waters remained intact, but were soft to the touch. The CB4 specimen immersed in Bitterns was softer than the specimen in Brine, but the one in Process water was normal and hard. CB2 performed normally and even improved in the slake test. They remained intact and became harder over time.

CB2 and CB4 both gained weight, but changed little in volume. All of the specimens hardened in Process waters, while CB3 and CB4 specimens in Brine and Bittern softened due to immersion, while CB2 specimens hardened. Ideally, the samples would have a change in weight of less than about 30%, and preferably less than about 25% after about 85 days, and a change in volume of less than about 10%, and preferably less than about 5% after about 85 days.

### 3. Unconfined Compressive Strength of CB

In addition to compatibility tests, penetration resistance and unconfined compressive strength (UCS) tests were performed on CB test specimens under standard cure conditions to gauge material strength and changes in strength with continued curing. A summary of these results can be found in Table 7.

TABLE 7
Unconfined Strength of CB

| | Ingredients (%) | | | | | | | |
|---|---|---|---|---|---|---|---|---|
| Mix | (PC/BFS/ | Mix | Penetrometer (tsf) | | | UCS (psi) | | |
| No. | Bento/Sep) | Water | Day 1 | Day 3 | Day 6 | Day 7 | Day 28 | Day 90 |
| Normal | as required | Clean? | >0 | >1 | >2 | >5 | >15 | >25 |
| CB | | | | | | | | |
| CB1 | 17/0/0/5 | Brine | 0 | 0 | 0 | 0 | DNT | DNT |
| CB2 | 17/0/6/0 | Process | 0.16 | 0.28 | 0.75 | 13 | 18 | 25.4 |
| CB3 | 1.6/15.6/0/6 | Process | 0.14 | 2.25 | 3.75 | 76 | 146 | 175.9 |
| CB4 | 1.6/15.6/5/0 | Process | 0.08 | 0.75 | 2.5 | 32 | 71 | 103.1 |

CB3 and CB4 were much stronger than CB2, due to the inclusion of BFS in the mixtures. CB2 presented highly desirable results for a CB made with Portland cement.

### 4. Summary of Grout Compatibility

A summary of CB grout compatibility is shown in Table 8.

TABLE 8
Summary of Grout Testing

| PROPERTY | Conventional | CB1 | CB2 | CB3 | CB4 |
|---|---|---|---|---|---|
| Cement | Portland | PC V | PC V | BFS/PCV | BFS/PCV |
| Clay | Bentonite | Sepo | Bento | Sepo | Bento |
| Mix Water | Clean | Brine | Process | Process | Process |
| Cement/W | 0.15 to 0.22 | 0.17 | 0.17 | 0.172 | 0.172 |
| Clay/W | 0.04 to 0.06 | 0.05 | 0.06 | 0.06 | 0.05 |
| Density (gm/cc) | 1.13 | 1.30 | 1.13 | 1.14 | 1.13 |
| Viscosity | >35 | 37 | 32 | 51 | 30 |
| (MF sec) | | | | | |
| Bleed (%) | <10 | 0 | 2 | 0 | 4 |

CB2 and CB4 performed better than CB1 and CB3, according to this summary.

### 5. SB and CB Permeability Testing

Permeability tests were performed in accordance with ASTM D5084. Mixtures of soil and bentonite (“SB1” and “SB2”) were also tested for compatibility and permeability. Specimens were consolidated to a low effective confining stress (6 psi for SB and 10 psi for CB or “cement bentonite”) until the specimens were saturated and stable. The hydraulic driving test pressure was limited to 2 psi (hydraulic gradient<30). The specimens were then permeated with Brine water for 10-14 days, until the results were stable. The previously-described testing led to the conclusion that: SW 101 was the best clay for use in a slurry wall; CB2 was the best grout for a slurry wall; and 1B Brine was the worst case permeant. Thus, for purposes of these tests, these materials were utilized to perform permeability tests on several mixtures to gauge the permeability of the materials. These results are shown in Table 9.

TABLE 9
Permeability Test Results

| | | | | Permeability |
|---|---|---|---|---|
| | Ingredients (%) | Water | | (hydraulic |
| | (PC/BFS/Bento/Sep) | Content | | conductivity) |
| Mix. No. | (%) | (%) | Density | (cm/sec) |
| SB1 | 0/0/3.5/0 | 43.5 | 99 | 2.90E−07 |
| SB2 | 0/0/6/0 | 50.5 | 98 | 8.20E−08 |
| CB2 | 17/0/6/0 | 292 | 72 | 6.00E−09 |
| CB3 | 1.6/1.56/0/6 | 345 | 71.8 | 2.50E−08 |
| CB4 | 1.6/1.56/5/0 | 339 | 71.2 | 1.10E−08 |

Interestingly, the CB specimens provided lower permeability results than the SB. Mix SB1 with 3.5% SW 101 bentonite produced a surprisingly high permeability result, while mixture CB2 had the lowest results.

In light of the overall results, a CB slurry wall would seem to be preferable, particularly when used atop narrow (e.g., 15-feet wide) dikes. In light of the above testing, CB2 seems to be the ideal mixture, and its properties are summarized in Table 10.

TABLE 10

| PROPERTY | MIX NO. | CB2 |
|---|---|---|
| Ingredients | (PC/BFS/Bento) % | 17/0/6 |
| Mix Water | (source) | Process |
| Bleed | (cc/100 ml) | 2 |
| Density | (g/cc) | 1.13 |
| Visc | (MF sec.) | 32 |
| UCS | (28 day in psi) | 18 |
| UCS | (90 day in psi) | 25 |
| Permeability | (cm/sec) | 6.0E−09 |

### Slurry Wall Formation

A test dike was selected adjacent a test brine storage pond. This dike had an average width at the top of about 19 feet. Its base width was about 37 feet. The dike's overall height was about 8 feet on one side and 10 feet on the other. A trench was dug in the dike around the pond, which put the trench down into native clay. The depth of the slurry wall was selected between 20-30 feet, depending on the height of the dike and the depth to the native clay layer. The width of the trench was about 5 feet. The slurry mixture used was CB2, tested and identified above. The slurry mixture was placed in the trench and allowed to harden in place. The trench depth was continuously checked, the excavated material was regularly reviewed, and the quality control of the CB mixture was monitored. After about 2 weeks, a covering was placed over the top of the wall.

Following completion of the slurry wall around the pond, brine from adjacent ponds was pumped into the pond and leakage monitored. During the month after the slurry wall was installed, there was no measurable leakage. The test pond was further monitored over the course of about 18 months. This monitoring showed that, other than pumping in and out and rise from precipitation, the test pond level had not dropped. During weeks 61-65, when very little precipitation occurred, a very flat trend was observed, which further confirmed that the slurry wall had accomplished the goal of reducing leakage losses from the brine storage pond.

The benefits of sealed ponds to increased mineral separation productivity was extrapolated. Mass balances showed that a valuable quantity of concentrated brine was being lost through dike and pond leakage in prior art solar ponds. In most climates, the solar season length, the solar radiation, and the drivers for evaporation are limited. Pond leakage not only requires additional pumping to make up for the losses, it also robs the system of concentrated brine. That brine has absorbed the finite solar energy, has concentrated through evaporation, and now leaves the system with its valuable minerals. If leakage could be stopped, the brine that has been concentrated with the finite solar energy, would be retained in the system and would result in additional mineral deposit. An 85% reduction in leakage would result in a 60% increase in the deposit of valuable minerals.

As an alternative to the slurry wall described above, a sheet piling could be utilized. The sheet piling provides the same leakage barrier as the slurry wall and will result in the same reduction in leakage. If the dike material is too hard to drive the sheet piling through, a trench could be dug down to the native soil, the sheet piling could then be driven through, and the trench backfilled. Sheet piling may also be appropriate where dike material is not as hard, or fresh water is not available to hydrate the cement and clay.

The installation of a barrier wall in unlined solar pond systems according to the invention will result in increased minerals separation and thus increased productivity (at least about 40 tons per acre, and preferably at least about 50 tons per acre) of the ponds. If a leakage barrier is installed, less brine will need to be pumped to make up for losses to the substrate. Prior to the present invention, no one has developed a system for retaining concentrated brines in an unlined solar pond in a manner that approaches the benefit of a lined pond in order to take advantage of this potential increase in productivity of the solar pond system.

### Slurry Mixture Testing II

Further testing was carried out to identify further slurry mixture formulations that might be useful. In particular, one goal was to identify a mixture that could be made using brine from the Great Salt Lake. This would be useful for ponds around the Great Salt Lake, as well as other areas where fresh water is not readily available.

Four commercial clays, three polymers (see Table 2), and various additives were mixed with SGSL and NGSL brines and made into twenty-two slurries for evaluation. Standard API tests were performed on the mixtures. Tables 11A-11C summarize the results and compare these slurries to a typical API bentonite slurry.

TABLE 11A
Clay/Polymer Slurry Properties

| | Typical | | | | | | | | |
|---|---|---|---|---|---|---|---|---|---|
| PROPERTY | API | 1 | 2 | 3 | 4 | 5 | 6 | 7 | 8 |
| Clay | Bentonite | Sepio | Sepio | Sepio | Sepio | Atta | Atta | SW 101 | BSA |
| Mix Water | Fresh | SGSL | SGSL | SGSL | NGSL | SGSL | SGSL | SGSL | SGSL |
| Mixer | Std | Std | Std | Std | Std | Std | Std | Std | Std |
| Clay/W % | 6.4 | 8% | 9% | 10% | 9% | 8% | 9.5% | 6% | 6% |
| Density | 1.03 | 1.146 | 1.154 | 1.154 | 1.234 | 1.146 | 1.154 | 1.138 | 1.154 |
| (gm/cc) | | | | | | | | | |
| Theo Density | 1.037 | 1.12 | 1.126 | 1.132 | 1.252 | 1.12 | 1.129 | 1.11 | 1.12 |
| Bleed | 0 | — | 0% | — | 2% | — | 8% | 82% | — |
| (ml/100 ml) | | | | | | | | | |
| MF (sec) | >40 | 30 | 33 | 34 | 34 | 29 | 31 | 33 | 28 |
| Gelatin (sec) | >35 | 23 | 23 | 21 | 21 | 19 | 19 | 24 | 20 |
| AV (cP) | >15 | 7 | 10.5 | 15.5 | 10 | 3.5 | 5.5 | 9.5 | 2.5 |
| YP (lb/100sf) | 20 | 10 | 19 | 27 | 16 | 3 | 9 | 13 | 3 |
| Filtrate (ml) | <15 | — | 87 | — | 78.8 | — | 95 | 26.8 | — |
| Cake | 0.5-1.5 | — | 0.34 | — | 0.26 | — | 0.28 | 0.18 | — |
| Th'ckness (inch) | | | | | | | | | |
| pH | 7-9 | 8.1 | 8.1 | 8.2 | 7.5 | 9.2 | 9.3 | 8.4 | 9.3 |
| Comments | 7-9 | Bubbles | Bubbles | Bubbles | Bubbles | Bubbles | bubbles | Grit | Settles |

TABLE 11B
Clay/Polymer Slurry Properties

| PROPERTY | 9 | 10 | 11 | 12 | 13 | 14 | 15 | 16 | 17 |
|---|---|---|---|---|---|---|---|---|---|
| Clay | BSA | HEC-N | HEC-N | HEC-N | HEC-N | HEC-N | HEC-N | HEC-K | HEC-K |
| Mix Water | SGSL | SGSL | SGSL | SGSL | SGSL | NGSL | NGSL | SGSL | SGSL |
| Mixer | Std | Std | Std | Std | Std | Std | Std | Std | Std |
| Clay/W % | 8% | 0.61% | 0.30% | 0.25% | 0.20% | 0.25% | 0.30% | 0.20% | 0.25% |
| Density | — | 0.95 | 1.098 | 1.090 | 1.106 | 1.154 | 1.186 | 1.106 | 1.090 |
| (gm/cc) | | | | | | | | | |
| Theo Density | 1.135 | 1.07 | 1.07 | 1.07 | 1.07 | 1.19 | 1.19 | 1.07 | 1.07 |
| Bleed | 73% | — | — | — | 0% | — | 0% | — | 0% |
| (ml/100 ml) | | | | | | | | | |
| MF (sec) | 28 | 157 | 48 | 42 | 37 | 32 | 46 | 29 | 33 |
| Gelatin (sec) | 19 | — | 38 | 31 | 26 | 22 | 32 | 19 | 28 |
| AV (cP) | — | — | 23 | — | 14 | 10 | 25 | 5 | 6.5 |
| YP (lb/100sf) | — | — | 40 | — | 22 | 12 | 40 | 4 | 9 |
| Filtrate (ml) | >400 | — | — | — | >400 | — | 39.6 | — | 19 |
| Cake | 0.33 | — | — | — | 0.01 | — | 0.03 | — | 0.01 |
| Th'ck (inch) | | | | | | | | | |
| pH | — | — | 8.5 | — | 8.5 | 7.7 | 7.8 | 8.3 | 8.6 |
| Comments | Settles | FOAMS | Bubbles | Ok | Ok | Foams | foams | fish eyes | fish eyes |

TABLE 11C

| PROPERTY | 18 | 19 | 20 | 21 | 22 |
|---|---|---|---|---|---|
| Clay | Sepio | Sepio | Sepio | Sepio | Sepio |
| Mix Water | SGSL | SGSL | SGSL | NGSL | NGSL |
| Mixer | hi shear | hi shear | hi shear | hi shear | hi shear |
| Clay/W % | 9% | 7% | 5% | 9% | 5% |
| Density | 1.11 | 1.11 | 1.12 | 1.18 | 1.16 |
| (gm/cc) | | | | | |
| Theo Density | 1.13 | 1.11 | 1.10 | 1.25 | 1.23 |
| Bleed | 0% | 0% | 0% | — | 0% |
| (ml/100 ml) | | | | | |
| MF (sec) | 71 | 46 | 37 | 74 | 35 |
| Gelatin (sec) | >> | 42 | 21 | >> | 26 |
| AV (cP) | 37.5 | 22.5 | 12.5 | — | 13 |
| YP (lb/100sf) | 65 | 43 | 23 | — | 24 |
| Filtrate (ml) | — | — | — | — | — |
| Cake | — | — | — | — | — |
| Th'k (inch) | | | | | |
| pH | 9 | 9.1 | 9.2 | 7.6 | 7.7 |
| Comments | Bubbles | bubbles | Fewer | bubbles | fewer |

Seventeen trial CB mixtures were made and tested for rheology and workability (Table 12). The materials in CB add solids and increase the density of the fluid, which can be theoretically calculated and checked (by absolute volume) to measure values.

TABLE 12
CB Mixtures and Fluid Properties

| | Ingredients | | | | | |
|---|---|---|---|---|---|---|
| | (PC, BFS, | | | | | |
| | Sepio, | | Theo | | | |
| Mix | Polymer, | Water | Den- | Measur'd | Viscosity | Viscosity |
| No. | Additive) | Source | sity | Density | (MF sec) | (AV cP) |
| CB1 | 17/0/9/0/0 | SGSL | 1.24 | 1.24 | 31 | 5.5 |
| CB2 | 17/0/0/0.3 | SGSL | 1.19 | 1.19 | 46 | 27.5 |
| | NH/0 | | | | | |
| CB3 | 0/12/9/0/0 | SGSL | 1.20 | 1.20 | 31 | 5 |
| CB5 | 17/0/0/0.3/0 | SGSL | 1.19 | 1.19 | 49 | 30 |
| CB6 | 17/0/6/0.2/0 | SGSL | 1.22 | 1.22 | 44 | 21 |
| CB7 | 17/0/10/0/0 | SGSL | 1.24 | 1.23 | 30 | 6.5 |
| CB8 | 17/0/0/ | SGSL | 1.19 | 1.07 | 86 | 52 |
| | 0.25/0.50 | | | | | |
| CB9 | 15/0/12/0/0 | SGSL | 1.19 | 1.20 | >90 | 71 |
| CB10 | 1/12/11/0/0 | SGSL | 1.22 | 1.19 | 76 | 36.5 |
| CB11 | 1/12/5/0 | SGSL | 1.19 | 1.18 | 32 | 7.5 |
| CB12 | 15/0/5/0 | NGSL | 1.34 | 1.24 | 35 | 17.5 |
| CB13 | 15/0/0/ | NGSL | 1.30 | 1.17 | 65 | 45 |
| | 0.25/0.50 | | | | | |
| CB14 | 1/12/0/ | SGSL | 1.18 | 1.23 | >150 | 35 |
| | 0.25/0.50 | | | | | |
| CB15 | 19/0/6/0 | NGSL | 1.37 | 1.34 | 42 | 25.5 |
| CB16 | 1.5/14/6/0 | NGSL | 1.34 | 1.31 | 34 | 10 |
| CB17 | 18/0/5/0 | SGSL | 1.22 | 1.24 | 37 | 21.5 |
| CB18 | 1/13/5/0 | SGSL | 1.19 | 1.28 | 30 | 7.5 |

Several mixtures (CB8, CB12, and CB 14) produced irregular densities due to foaming and bubbles. The first six mixtures used the standard mixer and did not produce the expected viscosity for the amount of sepiolite. The polymers (see Table 2) seemed to produce adequate viscosity at very low additive rates with a standard mixer.

Next, the setting properties of the CB mixtures were tested, including bleed and penetrometer resistance as well as Unconfined Compressive Strength (UCS) at 7 days. As the CB hardens, the goal is predictable hardening with minimal bleed. See Table 13.

TABLE 13
CB Mixtures Setting Properties

| | Ingredients | | | Penetration Tests | | | UCS |
|---|---|---|---|---|---|---|---|
| Mix | (PC, BFS, Sepio, | Bleed | pH | (tsf) | | | (psi) |
| No. | Polymer, Additive) | (%) | (unit) | 1 day | 3 day | 5 day | 7 day |
| CB1 | 17/0/9/0/0 | 15 | 11.8 | 0 | 0.047 | 0.125 | 9.2 |
| CB2 | 17/0/0/0.3/0 | 40 | 11.7 | 0 | 0.047 | 0.094 | 8.8 |
| CB3 | 0/12/9/0/0 | 8 | 9.8 | 0 | 0 | 0 | 0.34 |
| CB5 | 17/0/0/0.3/0 | 50 | 12 | 0 | 0 | 0.109 | 10.9 |
| CB6 | 17/0/6/0.2/0 | 37 | 11.9 | 0 | 0.016 | 0.094 | 8.8 |
| CB7 | 17/0/10/0/0 | 13 | 12.2 | 0.031 | 0.169 | 0.195 | 10.6 |
| CB8 | 17/0/0/0.25/0.50 | 40 | 12.3 | 0 | 0.047 | 0.219 | 18.9 |
| CB9 | 15/0/12/0/0 | 0 | 12.2 | 0.188 | 0.250 | 0.500 | 13.2 |
| CB10 | 1/12/11/0/0 | 0 | 10.3 | 0 | 0.109 | 0.234 | 17.4 |
| CB11 | 1/12/5/0 | 0 | 9.4 | 0 | 0.031 | 0.125 | 6.8 |
| CB12 | 15/0/5/0 | 2 | 10.2 | 0 | 0 | 0.063 | 3.7 |
| CB13 | 15/0/0/0.25/0.50 | 42 | 10.6 | 0 | 0 | 0.310 | 4.6 |
| CB14 | 1/12/0/0.25/0.50 | 0 | 9.2 | 0 | 0 | 0.000 | 0 |
| CB15 | 19/0/5.25/0 | 0 | 9.9 | 0 | 0 | 0.063 | 7.5 |
| CB16 | 1.5/14/5.25/0 | 0 | 8.5 | 0.5 | 0.031 | 0.109 | 2.1 |
| CB17 | 18/0/5/0 | 0 | 11.3 | 0 | 1.250 | 2.400 | 19.1 |
| CB18 | 1/13/5/0 | 0 | 9.4 | 0 | 0.031 | 0.203 | 8.5 |

CB mixtures CB 2, CB5, CB6, CB8, and CB13 had less desirable bleeds, and this group included most of the polymer mixtures. Polymer mixture CB14 did not bleed, but did not set properly. CB mixtures with SGSL brine generally performed better than those with NGSL brine.

Permeability and UCS tests were performed after 28 days, and UCS tests were performed again after 90 days. Table 14 shows these results.

TABLE 14
Hardened Properties of CB Mixtures

| | Ingredients | | | | | |
|---|---|---|---|---|---|---|
| | (PC, BFS, Sepio, | USC (psi) | | | Perm (cm/sec) | |
| Mix | Polymer, | | 28 | 90 | 28 day | |
| No. | Additive) | 7 day | day | day | start | end |
| CB1 | 17/0/9/0/0 | 9.2 | 14.7 | 20.8 | 5E−06 | 9E−07 |
| CB2 | 17/0/0/0.3 NH/0 | 8.8 | — | STOP | — | — |
| CB3 | 0/12/9/0/0 | 0.34 | — | STOP | — | — |
| CB5 | 17/0/0/0.3/0 | 10.9 | — | STOP | — | — |
| CB6 | 17/0/6/0.2/0 | 8.8 | — | STOP | — | — |
| CB7 | 17/0/10/0/0 | 10.6 | — | STOP | — | — |
| CB8 | 17/0/0/0.25/0.50 | 18.9 | — | STOP | — | — |
| CB9 | 15/0/12/0/0 | 13.2 | — | STOP | — | — |
| CB10 | 1/12/11/0/0 | 17.4 | 126.2 | 141.4 | 3.7E−07 | 1.9E−07 |
| CB11 | 1/12/5/0 | 6.8 | 89.3 | 135 | 5.8E−07 | 2.8E−07 |
| CB12 | 15/0/5/0 | 3.7 | — | STOP | — | — |
| CB13 | 15/0/0/0.25/0.50 | 4.6 | — | STOP | — | — |
| CB14 | 1/12/0/0.25/0.50 | 0 | — | STOP | — | — |
| CB15 | 19/0/5.25/0 | 7.5 | 65.5 | 125.9 | 2.0E−07 | 2.0E−07 |
| CB16 | 1.5/14/5.25/0 | 2.1 | — | STOP | — | — |
| CB17 | 18/0/5/0 | 19.1 | 28.3 | 46.4 | 1.6E−06 | 1.0E−06 |
| CB18 | 1/13/5/0 | 8.5 | 103.8 | 166.2 | 3.3E−07 | 3.0E−07 |

Slake tests were performed on select mixtures. Excessive flaking, cracking, peeling, decay, or disintegration of a test specimen, or a change of more than 10% in volume indicated a less desirable result. Tables 15, 15A, and 15B show these results, while Tables 16 and 17 show the CB design mix results.

TABLE 15
Slake Test Results

| | | Slake by Volume | | | Slake by Weight | | | |
|---|---|---|---|---|---|---|---|---|
| Mix | Age | SGSL | NGSL | 112 | SGSL | NGSL | 112 | |
| No. | (days) | % Δ Vol | % Δ Vol | % Δ Vol | % Δ Wt | % Δ Wt | % Δ Wt | Observations |
| | | SGSL | NGSL | 112 | SGSL | NGSL | 112 | Mix to be |
| CB1 | 49 | 9.0 | 4.7 | 5.3 | 0.5 | 7.6 | 6.5 | terminated |
| CB10 | 46 | 2.48 | 0.53 | −11.1 | 4 | 0.53 | 10.6 | 112 shows |
| CB10 | 76 | 2.15 | −0.21 | −11.36 | 6.4 | 12 | 12.1 | distress |
| CB11 | 60 | −0.28 | 1.14 | 0.11 | 3.7 | 13.4 | 10.7 | Mix |
| CB15 | 48 | 2.96 | coating | coating | 1.0 | Coating | coating | terminated |
| CB17 | 49 | 6.62 | 5.12 | 8.17 | 7.1 | 15.1 | 14.9 | chip off 112 |
| CB18 | 48 | −0.37 | 2.06 | −0.87 | 3.1 | 13.3 | 10.3 | coating of salt |
| | | | | | | | | SGSL may |
| | | | | | | | | peal |
| | | | | | | | | Very good. |

TABLE 15A
Slake Test Results

| | Ingredients | | | | | | | |
|---|---|---|---|---|---|---|---|---|
| | (PC, BFS, Sep, | | Slake by Volume | | | Slake by Weight | | |
| Mix | Polymer, | Age | SGSL | NGSL | 112 | SGSL | NGSL | 112 |
| No. | Additive) | (days) | % Δ Vol | % Δ Vol | % Δ Vol | % Δ Wt | % Δ Wt | % Δ Wt |
| CB1 | 17/0/9/0/0 | 49 | 9.0 | 4.7 | 5.3 | 0.5 | 7.6 | 6.5 |
| CB10 | 1/12/11/0/0 | 46 | 2.48 | 0.53 | −11.1 | 4 | 0.53 | 10.6 |
| | | 76 | 2.15 | −0.21 | −11.36 | 6.4 | 12 | 12.1 |
| CB11 | 1/12/5/0 | 60 | −0.28 | 1.14 | 0.11 | 3.7 | 13.4 | 10.7 |
| | | 112 | −0.46 | 0.54 | −0.18 | 3.5 | 15.6 | 8.1 |
| CB15 | 19/0/5.25/0 | 48 | 2.96 | coated | coated | 1.0 | coated | Coated |
| | | 100 | 4.63 | 13.28 | −13.79 | −0.1 | 19.5 | 20.5 |
| CB17 | 18/0/5/0 | 49 | 6.62 | 5.12 | 8.17 | 7.1 | 15.1 | 14.9 |
| | | 100 | 8.51 | 6.26 | 9.06 | 10.7 | 18.6 | 19.5 |
| CB18 | 1/13/5/0 | 48 | −0.37 | 2.06 | −0.87 | 3.1 | 13.3 | 10.3 |
| | | 100 | −0.21 | 2.02 | −0.68 | 4.1 | 16.4 | 12.8 |

TABLE 15B
Slake Test Observations

| | Ingredients | | | | | |
|---|---|---|---|---|---|---|
| Mix | (PC, BFS, Sepio, | | Observations > 100 days | | | |
| No. | Polymer, Additive) | Leachate | Color | Hard/Soft | Liquor | General |
| CB1 | 17/0/9/0/0 | All | grey | softer | p. cloudy | Mix terminated |
| CB10 | 1/12/11/0/0 | All | grey | softer | p. cloudy | NGSL & 112 |
| | | | | | | cracking |
| | | | | | | Mix terminated |
| CB11 | 1/12/5/0 | SGSL | white | softer | s. cloudy | |
| | | NGSL | black | harder | Clear | ok |
| | | 112 | black | harder | s. cloudy | ok |
| CB15 | 19/0/5.25/0 | SGSL | tan | starting to | s. cloudy | pealing |
| | | | | peal | | |
| | | NGSL | white | soft | s. cloudy | coating of salt |
| | | | | coating, | | gel |
| | | | | but hard | | |
| | | 112 | white | underneath | s. cloudy | coating of salt |
| | | | | | | gel |
| CB17 | 18/0/5/0 | SGSL | tan | starting to | Yellow | pealing |
| | | | | peal | | |
| | | NGSL | tan & | harder | Clear | Very good |
| | | | grey | | | |
| | | 112 | grey | harder | Clear | Very good |
| CB18 | 1/13/5/0 | SGSL | black | harder | s. cloudy | Very good, |
| | | | | | | smells |
| | | NGSL | black | harder | s. cloudy | Very good, |
| | | | | | | smells |
| | | 112 | black | harder | s. cloudy | Very good, |
| | | | | | | smells |

s. cloudy = slightly cloudy
p. cloudy = partially cloudy (worse than s. cloudy)

TABLE 16
Proportions, Fluid and Set Properties of CB Mixtures

| | | Ingredients | | | | Penetration Tests | | |
|---|---|---|---|---|---|---|---|---|
| Mix | | (PC, BFS, Sepio, | Water | Visc. | Bleed | (tsf) | | |
| No. | Mixer | Polymer, Additive) | Source | (MF sec) | (%) | 1 day | 3 day | 5 day |
| CB2 | Std. | 17/0/4&6B/0/0 | Process | 32 | 2 | 0.16 | 0.28 | X |
| CB1 | Std. | 17/0/9/0/0 | SGSL | 31 | 15 | 0 | 0.047 | 0.125 |
| CB10 | Hi Shear | 1/12/11/0/0 | SGSL | 76 | 0 | 0 | 0.109 | 0.234 |
| CB11 | Hi Shear | 1/12/5/0 | SGSL | 32 | 0 | 0 | 0.031 | 0.125 |
| CB15 | Hi Shear | 19/0/6/0.4* | NGSL | 42 | 0 | 0 | 0 | 0.063 |
| CB17 | Hi Shear | 18/0/5/0 | SGSL | 37 | 0 | 0.5 | 1.250 | 2.400 |
| CB18 | Hi Shear | 1/13/5/0 | SGSL | 30 | 0.5 | 0 | 0.031 | 0.203 |

*0.4 Thinner

TABLE 17
Hardened Properties of CB Mixtures

| | Ingredients | | | | Perm (cm/sec) | | Slake > 100 days | | |
|---|---|---|---|---|---|---|---|---|---|
| Mix | (PC, BFS, Sepio, | UCS (psi) | | | 28 day | | SGSL | NGSL | 112 |
| No. | Polymer, Additive) | 7 day | 28 day | 90 day | start | End | % Δ Vol | % Δ Vol | % Δ Vol |
| CB1 | 17/0/9/0/0 | 9.2 | 14.7 | 20.8 | 5.0E−06 | 8.9E−07 | softer | softer | softer |
| | | | | | | | | | vol |
| CB10 | 1/12/11/0/0 | 17.4 | 126.2 | 141.4 | 3.7E−07 | 1.9E−07 | softer | crackling | decrease |
| CB11 | 1/12/5/0 | 6.8 | 89.3 | 135 | 5.8E−07 | 2.8E−07 | white | ok | ok |
| | | | | | | | | | vol |
| CB15 | 19/0/6/0.4 | 7.5 | 65.5 | 125.9 | 2.0E−07 | 2.0E−07 | pealing | ok | decrease |
| CB17 | 18/0/5/0 | 19.1 | 28.3 | 46.4 | 1.6E−06 | 1.0E−06 | pealing | ok | ok |
| CB18 | 1/13/5/0 | 8.5 | 103.8 | 166.2 | 3.3E−07 | 3.0E−07 | ok | ok | ok |

We claim:

1. A method of reducing or preventing leakage from a solar pond, the method comprising forming a slurry wall in a dike adjacent said solar pond, said slurry wall being formed from a mixture comprising clay, cement, and water.

2. The method of claim 1, wherein said mixture comprises from about 3% to about 25% by weight cement, based upon the total weight of the mixture taken as 100% by weight.

3. The method of claim 1, wherein said cement is selected from the group consisting of Types II-V Portland cements, blast furnace slag cement, and mixtures thereof.

4. The method of claim 3, wherein said cement is a Type II-V, sulfate-resistant Portland cement.

5. The method of claim 1, wherein said mixture comprises from about 1% to about 15% by weight clay, based upon the total weight of the mixture taken as 100% by weight.

6. The method of claim 1, wherein said clay is selected from the group consisting of bentonite clay, modified bentonite clay, sepiolite clay, attapulgite clay, and mixtures thereof.

7. The method of claim 1, wherein said water comprises the following properties:
a pH of from about 6.0 to about 9.5;
a hardness of less than about 400 ppm;
an alkalinity of less than about 400 ppm;
a total dissolved solids of less than about 4,000 ppm;
a density of from about 1.0 gm/cc to about 1.04 gm/cc; and
an apparent viscosity of from about 0.8 cP to about 2 cP.

8. The method of claim 1, wherein said water comprises the following properties:
a pH of from about 7.0 to about 9.0;
a hardness of less than about 600 ppm;
an alkalinity of less than about 400 ppm;
a total dissolved solids of less than about 200,000 ppm;
a density of from about 1.05 gm/cc to about 1.21 gm/cc; and
an apparent viscosity of from about 0.8 cP to about 2 cP.

9. The method of claim 1, wherein said forming comprises:
forming a trench in said dike;
placing said mixture in said trench; and
allowing said mixture to harden in said trench to form said slurry wall.

10. The method of claim 9, said slurry wall having a top portion and further comprising covering said top portion.

11. The method of claim 1, said solar pond having a perimeter, and said slurry wall being formed along said entire perimeter.

12. The method of claim 1, wherein said slurry wall has a permeability of less than about 1×10⁻⁴ cm/sec.

13. The method of claim 1, wherein said slurry wall has an unconfined compressive strength of at least about 2.5 psig about 7 days after said slurry wall is formed.

14. The method of claim 1, wherein said slurry wall has a slake decay of less than about 25% by volume at about 30 days after said slurry wall is formed.

15. The method of claim 1, wherein said mixture is capable of hardening within about 7 days after said slurry wall is formed, as measured by a penetrometer.

16. The method of claim 1, wherein said mixture has a Marsh Funnel viscosity of from about 20 seconds to about 70 seconds.

17. A modified solar pond comprising:
a solar pond having a dike adjacent thereto; and
a slurry wall in said dike, said slurry wall being formed from a mixture comprising clay, cement, and water.

18. The pond of claim 17, wherein said mixture comprises from about 3% to about 25% by weight cement, based upon the total weight of the mixture taken as 100% by weight.

19. The pond of claim 17, wherein said cement is selected from the group consisting of Types Portland cements, blast furnace slag cement, and mixtures thereof.

20. The pond of claim 19, wherein said cement is a Type II-V, sulfate-resistant Portland cement.

21. The pond of claim 17, wherein said mixture comprises from about 1% to about 15% by weight clay, based upon the total weight of the mixture taken as 100% by weight.

22. The pond of claim 17, wherein said clay is selected from the group consisting of bentonite clay, modified bentonite clay, sepiolite clay, attapulgite clay, and mixtures thereof.

23. The pond of claim 17, wherein said water comprises the following properties:
a pH of from about 6.0 to about 9.5;
a hardness of less than about 400 ppm;
an alkalinity of less than about 400 ppm;
a total dissolved solids of less than about 4,000 ppm;
a density of from about 1.0 gm/cc to about 1.04 gm/cc; and
an apparent viscosity of from about 0.8 cP to about 2 cP.

24. The pond of claim 17, wherein said water comprises the following properties:
a pH of from about 7.0 to about 9.0;
a hardness of less than about 600 ppm;
an alkalinity of less than about 400 ppm;
a total dissolved solids of less than about 200,000 ppm;
a density of from about 1.05 gm/cc to about 1.21 gm/cc; and
an apparent viscosity of from about 0.8 cP to about 2 cP.

25. The pond of claim 17, said slurry wall having a top portion that includes a covering thereon.

26. The pond of claim 17, said solar pond having a perimeter, and said slurry wall being along said entire perimeter.

27. The pond of claim 17, wherein said slurry wall has a permeability of less than about 1×10⁻⁴ cm/sec.

28. The pond of claim 17, wherein said slurry wall has an unconfined compressive strength of at least about 2.5 psig about 7 days after said slurry wall is formed.

29. The pond of claim 17, wherein said slurry wall has a slake decay of less than about 20% by volume at about 30 days after said slurry wall is formed.

30. The pond of claim 17, wherein said mixture is capable of hardening within about 7 days after said slurry wall is formed, as measured by a penetrometer.

31. The pond of claim 17, wherein said mixture has a Marsh Funnel viscosity of from about 20 seconds to about 70 seconds.

32. A slurry wall formed from a hardened mixture, the mixture before hardening comprising:
from about 3% to about 25% by weight cement, based upon the total weight of the mixture taken as 100% by weight;
from about 1% to about 15% by weight clay, based upon the total weight of the mixture taken as 100% by weight; and
water.

33. The wall of claim 32, wherein said cement is selected from the group consisting of Types II-V Portland cements, blast furnace slag cement, and mixtures thereof.

34. The wall of claim 32, wherein said clay is selected from the group consisting of bentonite clay, modified bentonite clay, sepiolite clay, attapulgite clay, and mixtures thereof.

35. The wall of claim 32, wherein said water comprises the following properties:
a pH of from about 6.0 to about 9.5;
a hardness of less than about 400 ppm;
an alkalinity of less than about 400 ppm;
a total dissolved solids of less than about 4,000 ppm;
a density of from about 1.0 gm/cc to about 1.04 gm/cc; and
an apparent viscosity of from about 0.8 cP to about 2 cP.

36. The wall of claim 35, wherein said mixture comprises Portland Cement and bentonite.

37. The wall of claim 36, wherein said mixture comprises about 17% by weight Portland Cement and about 6% by weight benonite, based upon the total weight of the mixture taken as 100% by weight.

38. The wall of claim 32, wherein said water comprises the following properties:
a pH of from about 7.0 to about 9.0;
a hardness of less than about 600 ppm;
an alkalinity of less than about 400 ppm;
a total dissolved solids of less than about 200,000 ppm;
a density of from about 1.05 gm/cc to about 1.21 gm/cc; and
an apparent viscosity of from about 0.8 cP to about 2 cP.

39. The wall of claim 38, wherein said mixture comprises Portland Cement, blast furnace slag cement, and sepiolite.

40. The wall of claim 39, wherein said mixture comprises about 1% by weight Portland Cement, about 12.5% by weight blast furnace slag cement, and about 5.5% by weight sepiolite, based upon the total weight of the mixture taken as 100% by weight.

41. The wall of claim 32, wherein said slurry wall has a permeability of less than about 1×10⁻⁴ cm/sec.

42. The wall of claim 32, wherein said slurry wall has an unconfined compressive strength of at least about 2.5 psig about 7 days after said slurry wall is formed.

43. The wall of claim 32, wherein said slurry wall has a slake decay of less than about 20% by volume at about 30 days after said slurry wall is formed.

44. The wall of claim 32, wherein said mixture is capable of hardening within about 7 days after said slurry wall is formed, as measured by a penetrometer.

45. The wall of claim 32, wherein said mixture has a Marsh Funnel viscosity of from about 20 seconds to about 70 seconds.
